(19) United States
(12) Patent Application Publication
(10) Pub. No.: US 2022/0189285 A1
(43) Pub. Date: Jun. 16, 2022

(54) EMERGENCY PERSONAL MEDICAL DEVICE

(71) Applicant: Universal Physicians, LLC, North Canton, OH (US)

(72) Inventors: Andy C. Kutscher, Canton, OH (US); Joseph E. Frantz, Massillon, OH (US)

(73) Assignee: Universal Physicians, LLC, North Canton, OH (US)

(21) Appl. No.: 17/546,308

(22) Filed: Dec. 9, 2021

Related U.S. Application Data
(60) Provisional application No. 63/124,171, filed on Dec. 11, 2020.

(51) Int. Cl. G08B 25/01; H04B 1/3888

(52) U.S. Cl. CPC G08B 25/016; H04B 1/3888

(57) ABSTRACT

A personal medical device is disclosed that enables direct connection with emergency services dispatch via an emergency wireless network. The medical device includes an internet-enabled device, a case configured to engage the internet-enabled device and an assembly having an emergency button provided thereon. The medical device automatically contacts emergency services when the emergency button is depressed. The assembly stores information relating to the user and to trusted emergency contacts. When the emergency button is depressed the medical device automatically contacts emergency services and may initiate an audio, video, or text link with one or more of the stored emergency contacts utilizing a standard wireless internet connection and/or a connection through the internet-enabled device. The medical device enables two-way audio and video communication with the contacted parties.

### CROSS REFERENCE TO RELATED APPLICATIONS

This application claims the benefit of U.S. Provisional Application Ser. No. 63/124,171, filed on Dec. 11, 2020; the disclosure of which is incorporated herein by reference.

### TECHNICAL FIELD

The present disclosure relates generally to a personal medical device. More particularly, the present disclosure relates to an emergency personal medical device including an assembly provided as part of a case for an internet-enabled device. Specifically, the present disclosure relates to an emergency personal medical device operative to automatically contact emergency services and other emergency contacts in the event of a medical emergency upon a user depressing an emergency button provided on the assembly of the personal medical device.

### BACKGROUND

### Background Information

Personal medical devices may include devices that are worn by an individual that are used primarily to contact emergency services in the event of an emergency. While not limited to these examples, these devices may include medical alert devices such as pagers, watches, necklaces, bracelets, or other similar wearable technology. Cellular telephones may also be used as a type of medical alert device by providing a way for a user to telephone or otherwise contact emergency services to get assistance. Additionally, several applications have been developed for use with cellular phones in order to enable a user to contact emergency services in a medical emergency, It is common for many of these devices to operate utilizing a cellular telephone plan, an internet connection, or the like to contact emergency services and many available personal medical devices require a subscription and/or monitoring service for proper functionality.

Other personal medical devices may utilize the emergency wireless network established by the Federal Communications Commission (FCC) which mandates that emergency service communications, such as phone calls made directly to 911 services, be connected even if the device is not currently subscribed to a wireless carrier plan or is not in range of a subscribed wireless tower. For devices utilizing the emergency wireless network, the only requirement is to be within range of an active cellular telephone tower. Personal medical devices utilizing this network, therefore, do not necessarily require a cellular telephone plan nor do they require an active internet connection, either directly or through an intermediate device.

Commonly, many known personal medical devices are configured as one-touch signaling devices, meaning that the devices include a single button or the like that connects the user directly to an emergency services' dispatcher. While these personal medical devices are important in times of emergency, particularly when the wearer or user of such a device is unable to reach or operate a telephone, typically the functionality of such devices is limited solely to a direct connection with emergency services. In instances where a person activates their personal medical device but is otherwise unable to reach or operate a secondary communications device, such as a landline telephone, it is up to emergency services personnel to locate and/or contact the victim's emergency contact person or persons. For example, in the common instance of a slip and fall where a person is injured it would typically be up to emergency services personnel responding to the call to determine who that victim's emergency contact is, the best way to get hold of that emergency contact, and to make such contact.

### SUMMARY

A personal medical device is described herein. The personal medical device allows for direct connection with emergency medical dispatch services via an emergency wireless network while simultaneously allowing the medical device to store and automatically contact one or more emergency contact persons utilizing a standard wireless internet connection and/or a connection through an intermediate device. The intermediate device may be a cell phone or another electronic communications device. The medical device includes a housing configured to engage the intermediate device. An emergency button is provided on the housing and is operatively engaged with various components in the medical device and/or intermediate device. Depressing the emergency button on the housing automatically sends a signal from the medical device to emergency services and/or other emergency contacts. The medical device enables two-way audio and video communication with the contacted parties.

In one aspect, an exemplary embodiment of the present disclosure may provide a medical device comprising a first piece of electronics; a case that extends around at least a portion of the first piece of electronics; and a second piece of electronics provided on the case, wherein the second piece of electronics is operative to notify emergency services of a medical emergency of a user of the first piece of electronics.

In one embodiment, the first piece of electronics is an internet-enabled device and the case extends around at least a portion of the internet-enabled device; and wherein the second piece of electronics is an assembly provided on the case and having an emergency button operative to be depressed by the user; and wherein through depression of the emergency button, the medical device is operative to notify emergency services of the medical emergency of the user.

In one embodiment, the internet-enabled device may be one of a cell phone, a tablet, a smart watch, a Personal Digital Assistant (PDA), a laptop computer, an eBook reader, a gaming console, and a remote control. In one embodiment, the internet-enabled device may be a cell phone and the case may be a cell phone case. In one embodiment, the internet-enabled device is a portable device. In one embodiment, the internet-enabled device is paired to the assembly. In one embodiment, the internet-enabled device may include a screen. In one embodiment, the screen may be operative to display a graphical user interface (GUI) in response to the depression of the emergency button. In one embodiment, the medical device may further comprise one or both of a microphone and a speaker which is activated in response to the depression of the emergency button, In one embodiment, the medical device may further comprise a screen and a camera provided on the internet-enabled device, wherein the screen and camera are selectively activated when the emergency button is depressed.

In one embodiment, the medical device may further comprise an indicator light provided on one of the case and the assembly, wherein said indicator light is operative to illuminate when the medical device is in an active state. In one embodiment, the medical device may further comprise a battery provided in the assembly. In one embodiment the case may include a cradle and the assembly is selectively detachably engaged with the cradle. In one embodiment the internet-enabled device may include one or more of a processor, a keypad control module, one or more memory modules, a vibration motor, a cellular transceiver, a wireless transceiver, a Near Field Communication (NFC) transceiver, an FM transceiver, a receiver, a multifunction input/output device, and a cellular network subscriber identification module (SIM). In one embodiment, the medical device may further comprise a connection between the internet-enabled device and the assembly. In one embodiment the connection is a physical connection. In one embodiment, the connection is a wireless connection.

In another aspect, an exemplary embodiment of the present disclosure may provide a method for contacting emergency services comprising providing a first piece of electronics; engaging a case with at least a portion of the first piece of electronics; providing a second piece of electronics on the case; activating the second piece of electronics; and sending an emergency signal to emergency services. In one embodiment, providing the first piece of electronics comprises providing an internet-enabled device; and providing the second piece of electronics includes providing an emergency button on the case for the internet-enabled device; and the method further comprises depressing the emergency button provided on the case; searching for an internet or data connection; sending the emergency signal to emergency services using the internet or data connection located in the search; and connecting the internet-enabled device to the emergency services.

In one embodiment the method may further comprise providing a cell phone as the medical device; and pairing the cell phone and the emergency button. In one embodiment the method may further comprise displaying a graphical user interface (GUI) on a screen of the cell phone in response to the depression of the emergency button. In one embodiment the method may further comprise activating a microphone and/or a speaker in response to the depression of the emergency button. In one embodiment, the method may further comprise activating a screen of the cell phone and establishing a video connection with a trusted contact in response to depressing the emergency button.

In another aspect, an exemplary embodiment of the present disclosure may provide a method for contacting a trusted contact comprising providing a medical device; engaging a case with the medical device; depressing a button on the case; searching for an internet or data connection; sending a contact request to the trusted contact; and connecting to the trusted contact with the medical device. In one embodiment the method may further comprise providing a cell phone as the medical device; and pairing the cell phone and the emergency button.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 is a rear, left side perspective view of a first embodiment of a personal medical device according to one aspect of the present disclosure.

FIG. 1A is an exploded, left side perspective view of the first embodiment of the personal medical device.

FIG. 1B is an exploded, left side perspective view of a second embodiment of the personal medical device in accordance with an aspect of the present disclosure.

FIG. 2 is an exemplary block diagram of the personal medical device of FIG. 1A or FIG. 1B according to one aspect of the present disclosure.

FIG. 3 is a bottom plan view of the personal medical device coupled to a cell phone.

FIG. 4 is a bottom plan view of an alternative embodiment of the personal medical device coupled to a cell phone.

FIG. 5A is a left side elevation view of an exemplary power supply charging the personal medical device and the cell phone.

FIG. 5B is a left side elevation view of an alternative exemplary power supply charging the personal medical device and the cell phone.

FIG. 6 is diagrammatic view of the personal medical device in operation according to one aspect of the present disclosure.

FIG. 7 is front elevation view of the personal medical device showing an exemplary user interface of the personal medical device according to one aspect of the present disclosure.

FIG. 8 is a rear, left side perspective view of a third embodiment of a personal medical device according to another aspect of the present disclosure.

FIG. 9 is an exploded rear, left side perspective view of the personal medical device of FIG. 8.

FIG. 10A is a decision tree and flow chart of one method of use for the personal medical device according to one aspect of the present disclosure.

FIG. 10B is a decision tree and flow chart of one method of use for the personal medical device according to another aspect of the present disclosure.

FIG. 11A is a decision tree and flow chart of one method of use for the personal medical device according to one aspect of the present disclosure.

FIG. 11B is a decision tree and flow chart of another method of use for the personal medical device according to one aspect of the present disclosure.

Similar numbers refer to similar parts throughout the drawings.

### DETAILED DESCRIPTION

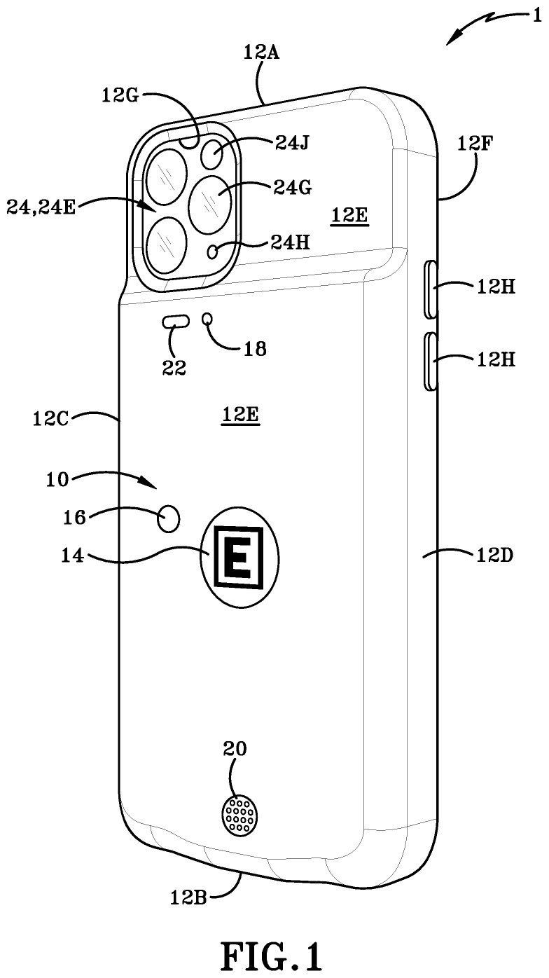

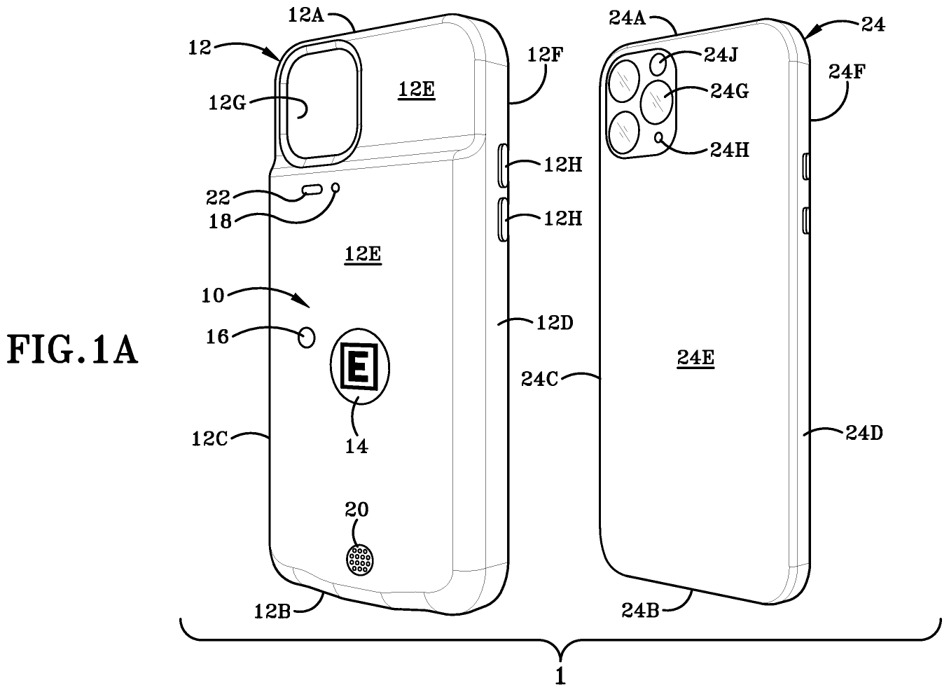

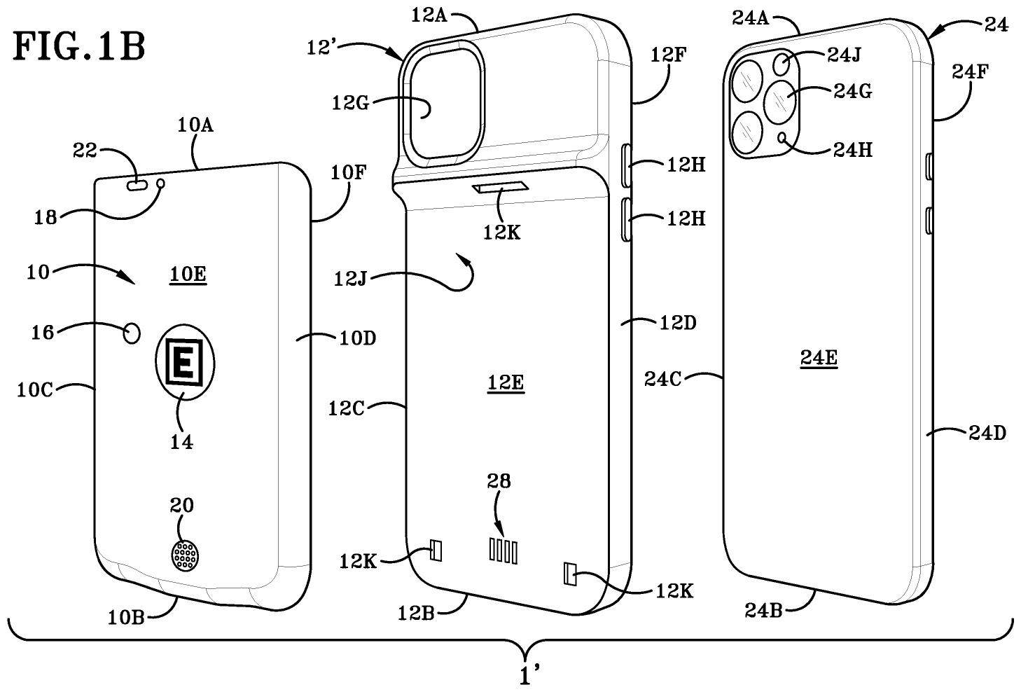

A new medical device and method of operation thereof is depicted in FIGS. 1-11B. The medical device is a new and improved apparatus, as will be discussed and described hereafter.

With reference to FIGS. 1 and 1A, a first embodiment of a personal medical device in accordance with the present disclosure is illustrated, generally indicated by the reference number “1”. Medical device 1 comprises an assembly 10, a case 12, and an internet-enabled device 24. The device 24 is an internet-enabled device, i.e., a device that is capable of connecting to the internet. It is contemplated that device 24 is portable and may be any of a cell phone, a tablet, a smart watch, a Personal Digital Assistant (PDA), a laptop computer, an eBook reader, a gaming console. The attached figures illustrate the internet-enabled device 24 is a portable device. In particular, the device 24 is illustrated as a cell phone. It will be understood that the cell phone 24 is exemplary of any other internet-enabled device which is portable.

It will be understood that the terms “cell phone” or “cellular phone” are used to denote any type of portable communication device that is internet-enabled. The terms “cell phone” and “cellular phone” may be used interchangeably throughout this specification. In particular, the terms are used to denote any and all mobile phones, cellular phones, cell phones, hand phones, or any other personal communication device or personal computing device. In particular, the mobile phone, cellular phone, cell phone, hand phone, or personal communication or computing device is one that preferably includes some type of cover which encapsulates at least a part of the portable device.

As will be described hereafter, case 12 comprises a body or a housing that is configured to be engaged around at least a portion of an exterior surface of the portable device 24. Since portable device 24 is illustrated as a cell phone, the case 12 is configured to be complementary to the portable device 24 and, as a consequence, is illustrated as a cell phone case 12. It will be understood, however, that if portable device is a tablet or eBook reader or any other portable internet-enabled device, case 12 will be complementary in configuration to at least a portion of the exterior surface of that differently configured portable internet-enabled device.

As illustrated in FIGS. 1 and 1A, assembly 10 is integrally formed with case 12. Case 12, in turn, is selectively detachably engageable with cell phone 24. Cell phone case 12 may additionally be referred to herein by the terms “case 12”, “cover 12”, “body 12”, or housing 12”; and the internet-enabled device 24 may also be referred to herein by the terms “portable device 24”, “device 24” or “cell phone 24”. Each of the assembly 10, case 12, and cell phone 24 will be described in greater detail hereafter.

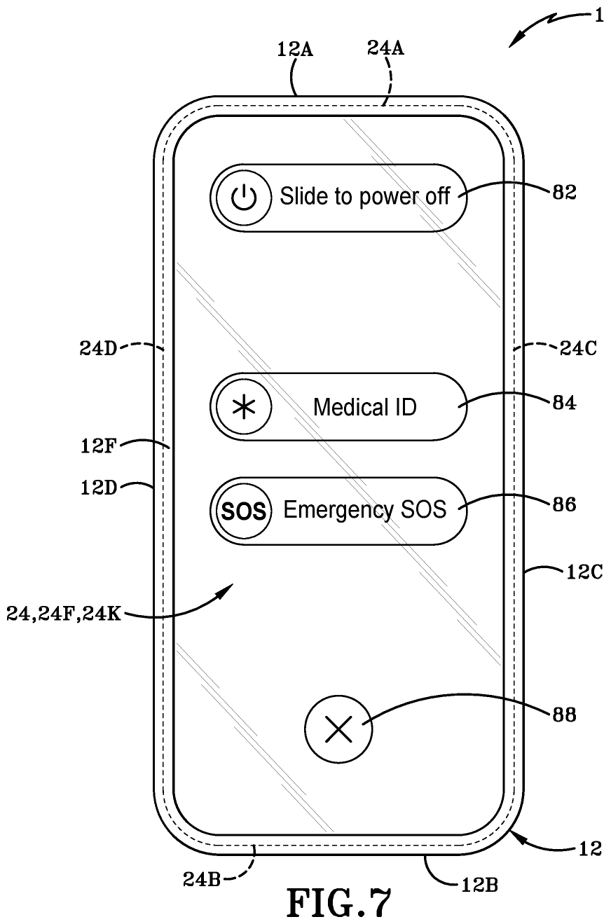

Referring to FIG. 1A, cell phone 24 includes a top 24A, a bottom 24B, a right side 24C, a left side 24D, a rear 24E and a front 24F. Top 24A is spaced apart from bottom 24B thereby defining therebetween a vertical direction. Right side 24C is spaced apart from left side 24D thereby defining therebetween a horizontal or transverse direction. Rear 24E is spaced apart from front 24F thereby defining therebetween the thickness of cell phone 24. The cell phone 24 may have various components provided thereon including, but not limited to, at least one rear facing camera 24G, at least one rear facing microphone 24H and at least one Light Emitting Diode (LED 24J. The cell phone 24 includes a plurality of operational components that may or may not be numbered in the attached drawings or are not illustrated in the attached drawings. These operational components may include, but are not limited to, On/Off buttons, volume control buttons, charging ports, a further microphone, a further speaker, and at least one indicator light or additional LEDs. A screen 24K (FIG. 7) is provided as part of front 24F of cell phone 24. The screen 24k is a touchscreen that is operative to display a Graphical User Interface (GUI). The user may use the GUI to operate the cell phone 24 and the assembly 10, as will be described later herein. All components of the cell phone 24 are well known in the art and therefore will not be further described herein safe as the components or the operation thereof pertains to the present disclosure.

As indicated earlier herein, case 12 is configured to be complementary to at least a portion of an exterior surface of the cell phone 24. Referring still to FIGS. 1 and 1A, case 12 has a top 12A spaced apart from a bottom 12B and defining therebetween a vertical direction. Case 12 has a right side 12C spaced apart from a left side 12D and defining therebetween a horizontal or transverse direction. Case 12 further includes a rear 12E spaced apart from a front 12F and defining therebetween the thickness of case 12. Case 12 may be ergonomically shaped along its top, bottom, and sides 12A, 12B, 12C, 12D so as to fit comfortably within a hand of a user.

It will be understood that case 12 is configured to wrap around an exterior surface of the rear 24E, top 24A, bottom 24B, right side 24C, and left side 24D of the complementary shaped cell phone 24, as is known in the art. Case 12 should therefore be considered as being exemplary of any cover or case for engagement with a particular configuration of cell phone 24, and the specific configuration of case 12 depicted in the attached drawings and described herein should not be considered as limiting the scope of the disclosure. Case 12 may include a plurality of projections and a plurality of recesses or apertures depending on the specific configuration of the cell phone 24 with which case 12 is to be engaged. As illustrated in FIGS. 1 and 1A, case 12 defines an aperture 12G that extends between rear 12E and front 12F. Aperture 12G is configured to be aligned with a region of cell phone 24 that includes the at least one rear facing camera 24G, the at least one rear facing microphone 24H, and the at least one LED 24J, when case 12 is engaged with cell phone 24. Case 12 further includes a plurality of projections 12H configured to be alignable with various buttons on the cell phone 24, such as the On/Off button and volume control button. Case 12 may include other projections (not shown) that may comprise movable flaps configured to align with and selectively cover openings to components such as charging ports provided on the cell phone 24.

Case 12 may be fabricated from any suitable material including but not limited to plastics, metal, or some combination thereof and may include other additional materials as dictated by the desired implementation. According to one aspect, case 12 may be sealed or may otherwise include one or more gaskets or similar sealing surfaces that may allow case 12 to be water-resistant or waterproof to aid in protecting any internal electronic components of cell phone 24.

In accordance with an aspect of the present disclosure, assembly 10 is formed as an integral part of case 12. In accordance with another aspect of the present disclosure, assembly 10 includes an emergency button 14 that is operatively engaged with a variety of components housed within an interior of case 12. The emergency button 14 is located in a region of the rear 12E of case 12 which makes the emergency button 14 readily accessible to a user. The emergency button 14 is shown in FIG. 1 as a circular button, but it will be understood that emergency button 14 could be any other desired shape operative to be depressed by a user.

The emergency button 14 may be formed of a rubberized or plastic material that imparts sufficient flexibility to the emergency button 14 to allow depression thereof relative to rear 12E of case 12. When emergency button 14 is depressed, an electronic circuit within assembly 10 is completed as dictated by the desired implementation. The functioning of emergency button 14, will be discussed further below with regards to the operation of device 10. The emergency button 14 may further be sealed so as to impart water-resistant or waterproof properties to emergency button 14, device 10, case 12, and/or cell phone 24.

Assembly 10 also includes a multifunction button 16, a microphone 18, a speaker 20, and an indicator light 22 which are all provided on the rear 12E of case 12. Emergency button 14, multifunction button 16, microphone 18, speaker 20, and indicator light 22 are all operatively connected, via electronic circuits, to a processor provided within the interior of case 12. Assembly 10 is configured to selectively electronically pair with the cell phone 24. When emergency button 14 is depressed, an associated electronic circuit within assembly 10 (i.e., within the interior of case 12) is closed and assembly 10 generates and sends an electronic signal to a remote emergency services dispatcher, as dictated by the desired implementation. In one aspect of the present disclosure, assembly 10 is operable to generate and send the emergency signal via a wireless network and may accomplish this by activating the cell phone 24 and sending the emergency signal via the cell phone 24. When emergency button 14 is depressed and the emergency signal has been sent, the microphone 18 and speaker 20 are activated to enable two-way communication with a remote emergency services dispatcher. Assembly 10 may further activate the screen 24K (FIG. 7) on cell phone 24 when emergency button 14 is depressed and thereby enable video communication with the remote emergency services dispatcher or with other parties such as trusted emergency contacts. This will all be discussed later herein.

Multifunction button 16 on assembly 10, i.e., on rear 12E of case 12 may be, as the name implies, utilized to control multiple functions of assembly 10, and or cell phone 24. For example, where no other buttons have been depressed, a brief depression of multifunction button 16 may provide a first function which may be, for example, a check of a battery provided in assembly 10. The battery in question may be a battery for operating assembly 10 on its own or the battery may provide power to assembly 10 and provide back-up power to cell phone 24 if needed. When the multifunction button 16 is depressed, an audible and/or visual indication may be provided to the user regarding the battery level, for example. The audible and/or visual indication may be delivered to the user via speaker 20 and/or indicator light 22, respectively. A longer depression and then a holding down of multifunction button 16 may provide a second function such as a resetting of assembly 10 or medical device 1, or a reset of a memory of a processor provided in assembly 10. When emergency button 14 has been depressed but was depressed unintentionally or if the user wishes to cancel an emergency signal for another reason, the cancelation may be accomplished by depressing and/or pressing and holding multifunction button 16. This may cancel the emergency signal and any other related transmissions from assembly 10 or from cell phone 24. For example, depression of multifunction button 16 may cancel the transmission of a video signal and/or a text messaging signal from cell phone 24.

Microphone 18 may be a standard miniaturized microphone similar to those found in personal communications devices such as cell phones and other similar devices and may be integrated into assembly 10 in any suitable position or location as dictated by the desired implementation. Similarly, speaker 20 may be any miniaturized speaker 20 similar to those commonly used in electronic devices such as cell phones and the like and the speaker 20 may operate in a similar manner to speakers provided in cell phones, for example.

Indicator light 22 may be a miniaturized light emitting diode (LED) or the like similar to those used in other electronic equipment. The indicator light 22 may be operable to display one or more colored lights indicative of a mode of operation of assembly 10, or a charge status of a battery in assembly 10, or a connection or connectivity status for the assembly, or any other relevant information relating to the assembly 10 that is capable of being displayed and communicated by an illuminated light. As mentioned above, indicator light 22 on assembly 10 may be utilized to indicate a battery charge status. For example, a green indication from indicator light 22 may indicate a suitable charge while an orange or yellow light may indicate a low charge and a red light may indicate a critically low charge. These colors are exemplary only and are understood to be one manner in which indicator light 22 may be used, not as a limiting example thereof. Accordingly, it will be understood that the indicator light 22 may be of any color or color combination as desired and may be utilized to provide any desired visual feedback to a user of assembly 10. According to another aspect, indicator light 22 may be used to show that assembly 10 is powered on and active. According to yet another aspect, indicator light 22 may be used to indicate an active and open connection by assembly 10 to one or more of emergency services, a video contact, and/or a contact group. For example, a blinking light or a specific light color displayed by the indicator light 22 may be utilized to indicate a connection to emergency services while a different blinking pattern (e.g. a faster or slower blink, as desired) may indicate an active video connection to a video contact.

Referring to FIG. 1B, a second embodiment of the medical device is illustrated, generally indicated by the reference character 1′. Medical device 1′ includes the cell phone 24 and a second embodiment of cell phone case for engagement therewith. The second embodiment of the cell phone case is generally indicated by the reference character 1′. A second embodiment of an assembly is also illustrated and generally indicated by the reference character 10′. In this second embodiment, the cell phone case 12′ The assembly 10′ is a separate, discrete component the is selectively detachably engageable with the case 12′, which in turn is selectively detachably engageable with the cell phone 24.

Assembly 10′ includes a top 10A, a bottom 10B, a right side 10C, a left side 10D, a rear 10E, and a front 10F. In assembly 10′, top 10A is spaced apart from bottom 10B defining therebetween a vertical direction, the right side 10C is spaced apart from a left side 10D defining therebetween a horizontal or transverse direction, and rear 10E is spaced apart from front 1OF defining therebetween a thickness of the assembly 10′.

In accordance with an aspect of the present disclosure, case 12′ is configured to form a cradle with which assembly 10′ is selectively removably engageable. The cradle, as illustrated in FIG. 1B, includes a recessed region 12J defined in rear 12E of case 12′. Recessed region 12J is complementary in shape and size to front 10F of assembly 10′. The cradle also includes some type of mechanism for securing assembly 10′ to case 12′. By way of example only, the illustrated mechanism provided to secure assembly 10′ to case 12′ includes a plurality of apertures 12K defined in the rear 12E of case. Apertures 12K are located and configured so as to receive a plurality of projections (not shown) that extend outwardly from front 10F of assembly 10′. When the projections on assembly 10′ are received in the apertures 12K, assembly 10′ is interlockingly engaged with case 12′. In other embodiments, interlocking ridges and grooves may be provided respectively, on case 12′ and assembly 10′ to allow assembly 10′ to be slidably selectively detachably engaged with case 12′. It will be understood that any mechanism that enables assembly 10′ to selectively removably engage with case 12′ may be employed in medical device 1′. It will further be understood that the configuration of recessed region 12J and assembly 10′ is exemplary only and any complementary configuration of these two components of medical device 1′ may be utilized. Case 12′ (or assembly 10′) may be sealed or may otherwise include one or more gaskets or similar sealing surfaces that may allow the interlocked assembly 10′ and case 12′ to be water-resistant or waterproof to aid in protecting any internal electronic components of assembly 10′.

Assembly 10′, as shown in FIG. 1A, is shaped to be complementary to the recessed region 12J of case 12′. Recessed region 12J of case is shown in FIG. 1A as including a wall located a short distance downwardly from aperture 12G. The wall is sloped at an angle and includes one of the apertures 12K for engagement of assembly 10′. Top 10A of assembly 10′ is complementary in slope so that when assembly 10′ is engaged in the cradle of case 12′, the angled wall of case 12′ and top 10A of assembly 10′ are in close abutting contact with one another. Sides 10C, 10D, and bottom 10B of assembly 10′ are gently curved so that when engaged with case 12′, the case 12′ is ergonomic in configuration and comfortable for a user of the cell phone 24 to hold in their hand.

In accordance with another aspect of the present disclosure, assembly 10′ includes an emergency button 14 that is operatively engaged with a variety of components housed within assembly 10′. In particular, emergency button 14 is provided on rear 10E of assembly 10′ in a location which makes the emergency button 14 readily accessible to the user when assembly 10′ is engaged with case 12′. The emergency button 14 provided on assembly 10′ is substantially identical in structure and function to the emergency button 14 provided on assembly 10. As such, the emergency button 14 may be formed of a rubberized or plastic material which imparts sufficient flexibility to the emergency button 14 to allow depression thereof relative to rear 10E. When emergency button 14 is depressed, an electronic circuit (not shown) within assembly 10′ is closed and assembly 10′ generates and sends an electronic signal to a remote emergency services dispatcher, as dictated by the desired implementation. Emergency button 14 is configured to be sealed in order to impart additional water-resistant or waterproof properties to assembly 10′.

Assembly 10′, like assembly 10, includes a multifunction button 16, a microphone 18, a speaker 20, and an indicator light 22 which are all provided on the rear 10E of assembly 10′. Emergency button 14, multifunction button 16, microphone 18, speaker 20, and indicator light 22 are all operatively connected, via electronic circuits, to a processor provided within the interior of assembly 10′. Assembly 10′ is configured to selectively electronically pair with the cell phone 24. In all other aspects, which will be described later herein, assembly 10′ functions in exactly the same manner as assembly 10.

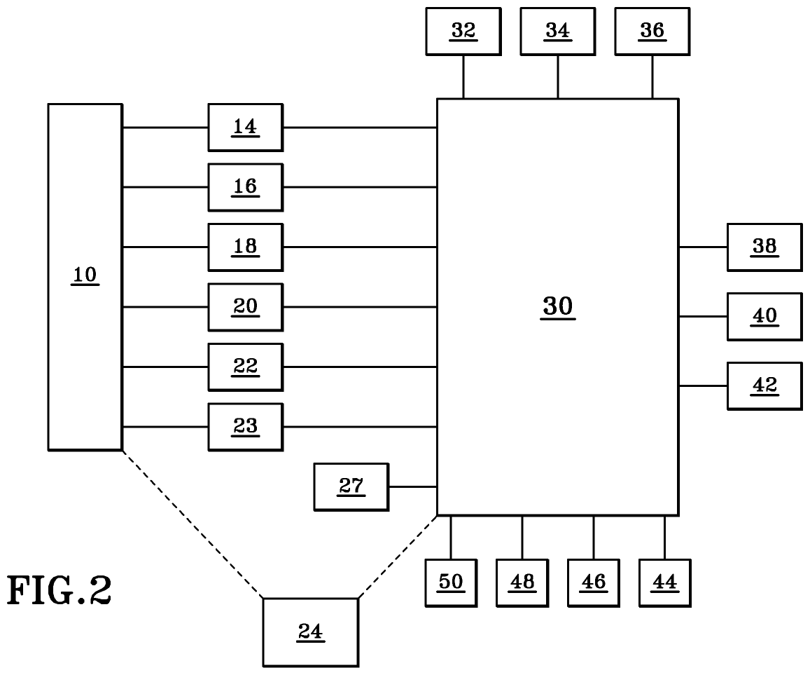

FIG. 2 is an exemplary block diagram showing various components that may form part of medical device 1 or medical device 1′. Accordingly, the assembly 10, 10′ of medical device 1, 1′, respectively, may include the emergency button 14, multifunction button 16, microphone 18, speaker 20, indicator light 22, and an internal rechargeable battery 23. According to another aspect, assembly 10 may have a removable or replaceable battery as dictated by the desired implementation. There may be additional components provided in assembly 10, 10′ that are not illustrated herein and some of the illustrated components may be omitted in other embodiments.

FIG. 2 shows some of the components that may form part of medical device 1, 1′ as including an audible alarm 27. The audible alarm 27 may beep or provide another audible signal to help direct others to the location of medical device 1, 1′ and thereby to the location of the person in need of medical attention. At least one processor 30 is provided in medical device 1, 1′ along with a keypad control module 32, one or more memory modules 34, a vibration motor 36, a cellular transceiver 38, for example a wireless transceiver such as a BLUETOOTH® transceiver. (BLUETOOTH® is a registered trademark of BLUETOOTH SIG, INC. of Kirkland, Wash., USA.) Additional components may include a Near Field Communication (NFC) transceiver 40, an FM transceiver 42, a receiver 44, a multifunction input/output device such as a USB module 46, a LED or light control module 48, and a cellular network subscriber identification module (SIM) 50. Processor 30 includes programming configured to enable the issuing of an emergency alert when emergency button 14 is depressed on assembly 10, 10′, to control the various components of medical device 1, 1′, and to interact with various networks external to medical device 1, 1′ as needed. It will understood that some of the above-listed components are provided in assembly 10, 10′ while others may be provided in cell phone 24.

Each of these components may be arranged or configured within medical device 1, 1′ as dictated by the desired implementation and may be operated according to their normal operation and/or according to the operation of their corresponding components as discussed further below. According to one example, vibration motor 36 may be any standard haptic or physical feedback system as dictated by the desired implementation. For example, vibration motor 36 may be a miniaturized vibrator as commonly used in consumer electronics such as cell phones, pagers, and the like. Vibration motor 36 may provide haptic or vibration feedback to a user of the medical device 1, 1′ for any desired purpose including, but not limited to, indicating connections via vibration patterns or haptic feedback patterns to indicate that medical device 1, 1′ is connected to emergency services, to a video contact, and/or that a group messaging signal has been sent by medical device 1, 1′, and/or delivered to emergency services, to a video contact, or to a trusted contact. According to one aspect, vibration motor 36 may also indicate disconnection of communication between medical device 1, 1′, and any third party contacts.

As a further example, the BLUETOOTH® transceiver 40 may be operated to enable assembly 10, 10′ to generate and receive BLUETOOTH® signals from cell phone 24 as discussed in the communication methods discussed below.

It will be understood that assembly 10, 10′ may further include other features not discussed herein as dictated by the desired implementation. According to one aspect, an additional feature that may be included or utilized is that of a Global Positioning System (GPS) module or component. Such a GPS module may allow emergency services to locate medical device 1, 1′ when activated by the emergency button 14. This feature may help direct emergency services to the user of medical device 1, 1′ in the event that the user is incapacitated or otherwise unable to provide an accurate indication of the user's location to emergency services.

These aforementioned components illustrated in FIG. 2 may all be interfaced and operatively connected with the assembly 10 to allow control and usage of the components of the cell phone 24 as if they were an extension of the assembly 10 itself. Alternatively, in a further embodiment, the cell phone 24 may control the assembly 10 as if it were an extension of the assembly 10 itself. Assembly 10 and cell phone 24 in one embodiment may be physical connected and/or have an active a data link via NFC or BLUETOOTH® connection. This connection is illustrated in FIG. 2 by the linking of the assembly 10 to the BLUETOOTH® transceiver or NFC transceiver 40. While the link is shown as a physical connection FIG. 2, it will be understood that the connection may be a digital handshake or other connection.

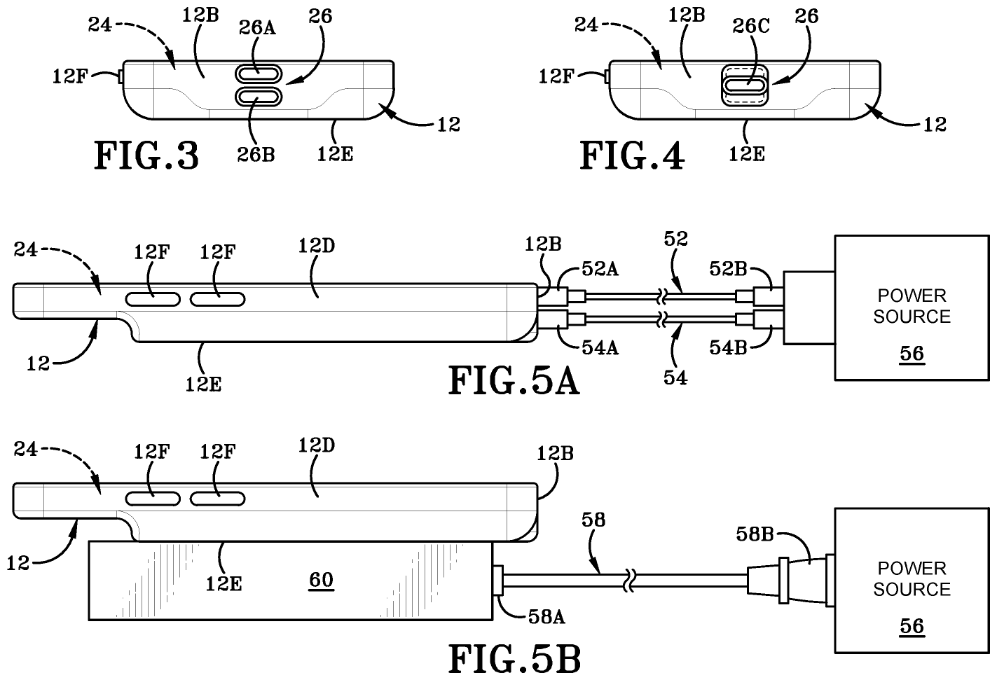

FIGS. 3-5B show various charging apparatuses and ports in conjunction with the assembly 10 or 10′. Specifically referring to FIG. 3, the bottom 12B of the case 12 is shown with two charging nodes 26, namely a first charging node 26A and a second charging node 26B. In an exemplary embodiment, the first charging node 26A charges the cell phone 24 while the second charging node 26B charges the assembly 10 or 10′, or vice versa. In an alternative embodiment, illustrated in FIG. 4, there is shown to be a single charging node 26C. This charging node 26C will be used to power both the cell phone 24 and the assembly 10 or 10′ because the assembly 10 or 10′ and cell phone 24 are in electronic connection with one another, or because the interface is designed in such a way as to be capable over powering both the assembly 10 or 10′ and the cell phone 24. According to one aspect, the charging nodes 26 are capable of being selectively sealed to aid in ensuring the water-resistant or waterproof capabilities of assembly 10 or 10′ and cell phone 24. According to another aspect, charging nodes 26 may be replaced by a sealed or otherwise water-resistant charging port (not shown) as dictated by the desired implementation. The nodes 26 or charging ports enable recharging of the internal rechargeable battery 23.

Referring to FIG. 5A and FIG. 5B, exemplary power sources are shown. Specifically referring to FIG. 5A, a first power cable 52, a second power cable 54 and a power source 56 is shown. A first end 52A of the first power cable 52 connects to the charging port of the cell phone 24 via charging node 26A (FIG. 3) while the second end 52B of first power cable 52 connects to the power source 56. A first end 54A of the second power cable 54 connects to the charging port of the assembly 10 or 10′ via charging node 26B (FIG. 3) while the second end 54B of the second power cable 54 connects to power source 56.

Obviously, if the medical device 1, 1′ includes only the single charging node 26C illustrated in FIG. 4, then a single power cable is needed to connect the assembly 10 or 10′ and cell phone 24 to the power source in order to recharge both assembly 10 or 10′ and cell phone 24.

Referring now to FIG. 5B, an alternative charging arrangement is shown. In this figure there is a single power cable 58 connecting a charging platform 60 to a power source 56. In particular, a first end 58A of the power cable 58 is connected to the charging platform 60 and the second end 58B of the power cable 58 is connected to the power source 56. The charging platform 60 is operative to wirelessly charge the assembly 10 or 10′ and optionally the cell phone 24 as well. While the examples are shown herein for the purpose of understanding and brevity, multiple other embodiments could be used for charging medical device 1, 1′ depending on the desired implementation.

Having thus described the elements and components of personal medical device 1, 1′, the operation and function thereof will now be discussed. Since the functioning of the medical devices 1, 1′ is substantially identical, the following description of the operation thereof will discuss only medical device 1 but applies equally to medical device 1′.

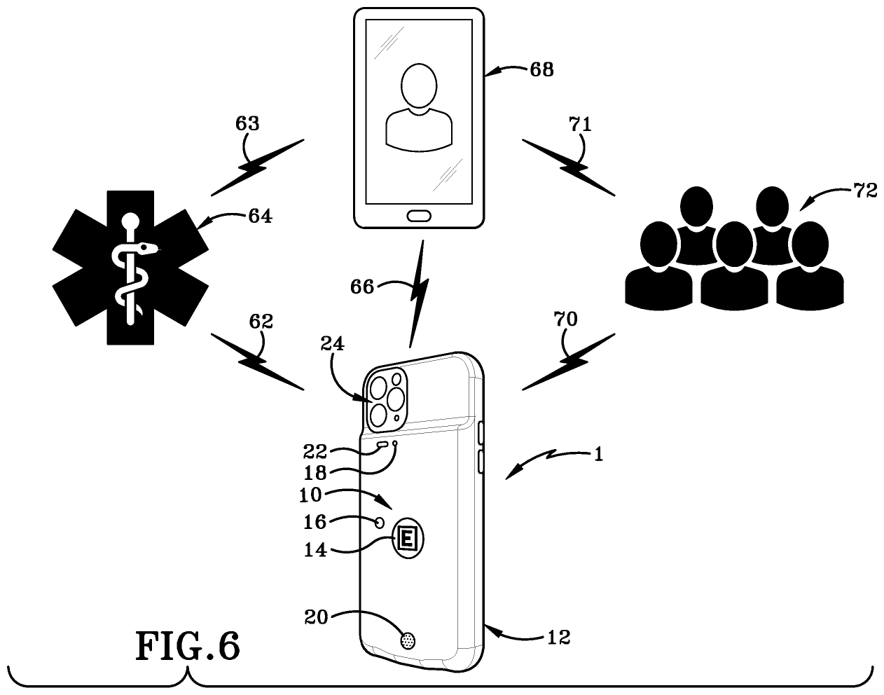

With reference to FIG. 6, medical device 1 is able to be utilized as a communication device in multiple ways. In a first mode of operation, medical device 1 is able to be utilized to contact emergency services 64 via an emergency signal 62. In this mode, a user depresses emergency button 14 which directs assembly 10 to generate and send out an emergency signal 62 via cellular transceiver 38 (FIG. 2) and/or FM transceiver 42. The signal may be generated and sent via the closest operable cellular or radio tower and may utilize the emergency wireless network to contact emergency services 64 without the need for a subscription-based service, a cellular telephone plan, or an active internet connection. If assembly 10 is within range of any active cellular or radio tower, assembly 10 may utilize this network to contact emergency services 64.

In a second mode of operation, medical device 1 may be utilized to connect with the cell phone 24 via the BLUETOOTH® transceiver 40 of assembly 10 or other similarly situated short range NFC signal and enables the cell phone 24 to contact emergency services 64 via emergency signal 62. In this second mode, the user depresses emergency button 14 which directs assembly 10 to generate and send out emergency signal 62 via the BLUETOOTH® transceiver 40. The signal 62 is recognized by the cell phone 24. The cell phone 24 then relays the signal 62 to the closest operable cellular or radio tower and may utilize the emergency wireless network to contact emergency services 64 without the need for a subscription-based service, a cellular telephone plan, or an active internet connection. If medical device 1 is within range of any active cellular or radio tower, the assembly 10 or cell phone 24 of medical device 1 may utilize this active cellular network to contact emergency services 64. Alternatively, if the cell phone 24 has an active cellular telephone plan, or an active internet connection, the emergency signal 62 may pass from the assembly 10 to the cell phone 24 and subsequently to the emergency services 64 via the active cellular telephone plan or active internet connection.

By way of one non-limiting example, if a user is carrying the medical device 1 on their person and has a slip and fall from which they cannot arise or otherwise operate a secondary communications device, the user may depress the emergency button 14 to generate the emergency signal 62 to contact emergency services 64. Once medical device 1 is connected to emergency services 64, the microphone 18 and speaker 20 of assembly 10 is activated to allow a two-way communications connection between the user and a dispatcher at emergency services 64 to allow the user to describe the nature of the emergency and, if necessary the user's location.

Referring still to FIG. 6, in addition to two-way audio connections, assembly 10 may enable additional types of communication between the user of medical device 1 and emergency services 64 and others 68, 72. A first additional type of communication may be a video connection via a video signal 66 sent directly to a cell phone or other electronic device of a predetermined emergency contact 68 utilizing the camera 24G (FIG. 1) provided on the cell phone 24. The contact information for video contact 68 may be preprogrammed into assembly 10 and stored in the memory 34 (FIG. 2) of device 10 such that when the emergency button 14 is depressed, device 100 simultaneously sends the emergency signal 62 to emergency services 64 and sends the video signal 66 to the emergency video contact 60. The video signal 66 may be sent to the emergency video contact 68 via one or more of cellular transceiver 38, BLUETOOTH® transceiver 40, and/or FM transceiver 42 of device 10.

According to one aspect, assembly 10, if connected to a wireless internet connection, may generate a wireless signal via FM transceiver 42 (FIG. 2) and may utilize the wireless internet connection to transmit the video signal 66 to video contact 68. Simultaneously, the camera 24G of the cell phone 24 may be activated along with microphone 18 and speaker 20 of assembly 10 (or a microphone and speaker of cell phone 24) to allow the video contact 68 to view whatever the camera 24G sees via a live video feed while allowing a two-way audio connection with the user of assembly 10 via microphone 18 and speaker 20 (or via the microphone and speaker of cell phone).

If an internet connection is not available to assembly 10, the video signal 66 may be sent via an active cellular subscription plan either directly, utilizing cellular transceiver 38 (FIG. 2), or indirectly such as through a BLUETOOTH® connection with a nearby cellular device via BLUETOOTH® transceiver 40. In this instance, the video signal will still be generated to video contact 68 while activating the camera 24G, microphone 18, and speaker 20 in the same manner as if sent over an internet connection. Where no subscription cellular plan or internet connection is available, assembly 10 may still contact emergency services via emergency signal 62 as discussed previously herein.

Another communications method enabled by assembly 10 includes generating and sending a group message signal 70 sent to a group of contacts 72. The contacts of the group of contacts 72 are individuals trusted by the user. The contact information for the group of contacts 72 will previously have been saved to the memory 34 (FIG. 2) of assembly 10. According to this aspect, when emergency button 14 is depressed, assembly 10 may send emergency signal 62 and video signal 66, as discussed previously herein, but may also generate group messaging signal 70 and send the same directly to the emergency contact group 72. It will be understood that the emergency signal 62, video signal 66, and group messaging signal 70 may be sent substantially simultaneously by device 10 or the signals 62, 66, 70 may be sent one at a time and in any order decided by the user and preprogrammed into the memory 34 of device 10.

Group messaging signal 70 may be a preselected or a preset Short Messaging Service (SMS) message and/or Multimedia Messaging Service (MMS) message which may be sent out via cellular transceiver 38 (FIG. 2) if medical device 1 is connected to an active cellular subscription plan, via BLUETOOTH® transceiver 40 by way of a secondary cellular device as described with respect to video signal 58, and/or via an active internet connection as also described earlier herein with reference to video signal 62. The assembly 10 may use the components of the cell phone 24 independent of the components of assembly 10 to generate and send out the signals other than providing an initial connection.

According to one aspect, assembly 10 may send an emergency message 70 to the group contacts 72 indicating that an emergency has occurred and providing further instructions. As with video signal 66, where an internet connection and/or an active cellular data connection is not available, assembly 10 may still contact emergency services 64 via emergency signal 62. According to another aspect, assembly 10 may send a signal to the cell phone 24 which in turn sends an emergency message 70 to the group contacts 72 indicating that an emergency has occurred and providing further instructions. As with video signal 66, where an internet connection and/or an active cellular data connection is not available, assembly 10 may still contact emergency services 64 via emergency signal 62.

As illustrated by the reference character 63 in FIG. 6, emergency services 64 may notify the emergency contact 68 of the user's emergency. Additionally or alternatively, the emergency contact 68 may notify the contact group 72 of the user's emergency as indicated by the reference character 71.

When emergency button 14 on medical device 1 is depressed, the screen 24K of cell phone 24. A Graphical User Interface (GUI) is displayed on screen 24k of cell phone 24 in response to the depression of the emergency button 14. FIG. 7 shows an exemplary GUI displayed on screen 24K in response to the depression of emergency button 14 The GUI displays various possible options on the screen 24K of the cell phone 24 that may be selected by the user (or by a person in the vicinity of the user if the user is incapacitated. The various possible options have been preprogrammed and stored in memory 34 of assembly 10. A first option which the user may select from the GUI by pushing the displayed icon is a power off option 82. With this option, a user may turn off the medical device 1. In particular, the user may select this first option 82 if he or she wishes to disconnect the assembly 10 from their cell phone 24 so that the assembly 10 is no longer able to be used to issue a medical emergency alert independently or via the cell phone 24. The user will follow the prompts on the screen 24K to accomplish this first option.

A second option which the user may select from the GUI on screen 24K is a medical identification (ID) option 84. This option, if selected, may display to the user or to a first responder a medical ID screen that displays various information regarding the primary user of the cell phone 24. (Obviously, the information regarding the primary user will have been previously stored in the memory 34 of assembly 10.) This information can be medical information which includes, but is not limited to, food allergies, drug allergies, drug interactions, current prescriptions, blood type, advanced care directives, current medical conditions, and/or Quick Response (QR) codes relating to medical information pertaining to the primary user of the cell phone 24. The information may also include phone numbers and other details regarding the primary user's trusted contacts. The user or the first responder (or any other party who may have initiated the emergency call via the medical device 1) may simply engage the icon on the screen 24K to select this second option and will follow any further prompts offered by the selection of the option once the medical ID screen is opened.

A third option of the GUI on screen 24K which the user may select is the emergency option 86 i.e., an “SOS” option 86. The emergency option 86 will trigger additional procedures to take place on medical device 1, as will be discussed further herein. The third option is selected by pushing the icon on screen 24K and following any other prompts that may be displayed once the option is selected.

A fourth option which the user may select on the GUI by pushing the associated icon on screen 24K is the cancel option 88. With this option 88, a user may indicate that the emergency button 14 was accidentally depressed. Selecting the fourth option 88 will terminate the operation of the medical device 1 until the emergency button 14 is depressed again. Selecting the fourth option 88 will cancel any signals that were sent out or were yet to be sent out by the medical device 1, as will be discussed further later herein. Selecting the fourth option will restore the normal operation of the cell phone 24.

The above-referenced options shown and discussed herein should not be construed as limiting the operation of the medical device 1. Instead, the options discussed herein are merely examples to demonstrate the possible types of operation of the medical device 1. It will be understood that medical device 1 may be programmed with additional options or fewer options than what are illustrated in FIG. 7. Additionally, it will be understood that the medical device 1 may be programmed to get the user to interact in a variety of different ways with the assembly 10 and with the GUI displayed on screen 24K of the cell phone 24. The four options and manner of interacting with the GUI described above are exemplary only.

In summary, in one aspect, an exemplary embodiment of the present disclosure may provide a medical device 1, 1′ comprising a first piece of electronics 24; a case 12, 12′ that extends around at least a portion of the first piece of electronics 24; and a second piece of electronics 10, 10′ provided on the case 12, 12′, wherein the second piece of electronics 10, 10′ is operative to notify emergency services 64 of a medical emergency of a user of the first piece of electronics 24. In one embodiment, the first piece of electronics 24 is an internet-enabled device and the case 12, 12′ extends around at least a portion of the internet-enabled device 24; and wherein the second piece of electronics 10, 10′ is an assembly provided on the case 12, 12′ and having an emergency button 14 operative to be depressed by the user; and wherein through depression of the emergency button 14, the medical device 1, 1′ is operative to notify emergency services 64 of the medical emergency of the user.

Furthermore, a method of using the present disclosure may be summarized providing a method for contacting emergency services 64 comprising providing a first piece of electronics 24; engaging a case 12, 12′ with at least a portion of the first piece of electronics 24; providing a second piece of electronics 10, 10′ on the case 12, 12′; activating the second piece of electronicsl0, 10′; and sending an emergency signal 62 to emergency services 64. In one embodiment, providing the first piece of electronics 24 comprises includes providing an internet-enabled device 24; and providing the second piece of electronics 10, 10′ includes providing an emergency button 14 in the case 12, 12′ for the internet-enabled device 24; and wherein the method further comprises depressing the emergency button 14 provided on the case 12, 12′; searching for an internet or data connection; sending the emergency signal 62 to emergency services 64 using the internet or data connection located in the search; and connecting the internet-enabled device 24 to the emergency services 64.

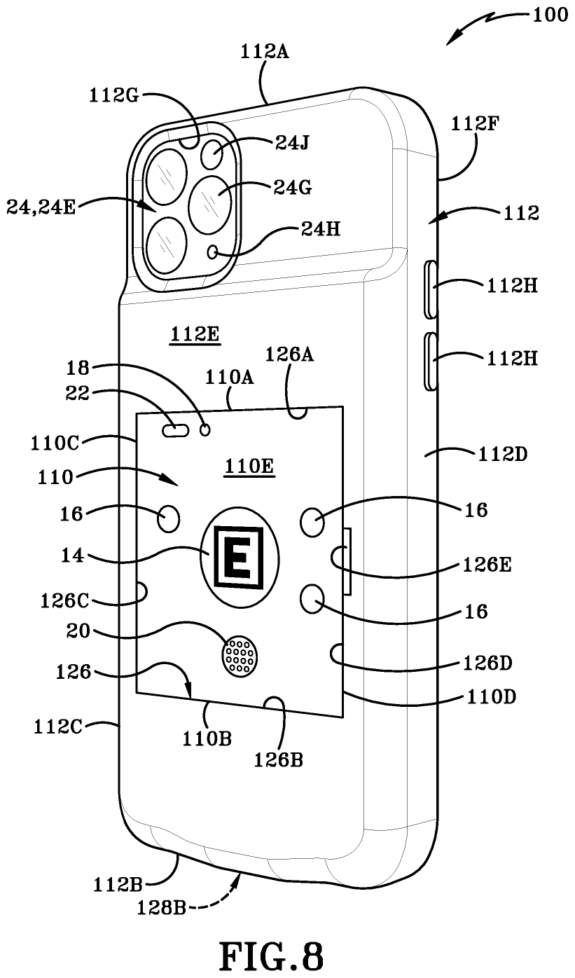

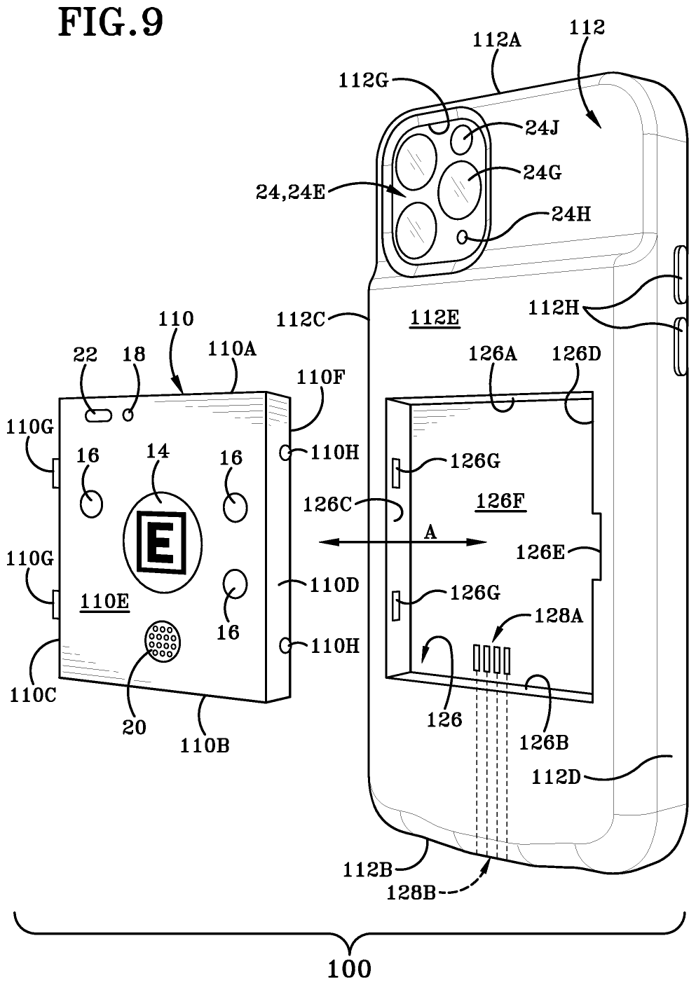

Referring now to FIGS. 8 and 9, a third embodiment of a personal medical device in accordance with an aspect of the present disclosure is shown and is hereinafter referred to as medical device 100. Medical device 100 is comprised of cell phone 24, a case 112 for cell phone 24, and an assembly 110. Medical device 100 functions in exactly the same manner as medical device 1, 1′ described above. Medical device 100 differs from medical device 1 (FIG. 1A) in that the assembly 100 is configured to be selectively detachably engaged with a specially configured case 112. Medical device 100 is similar to medical device 1′ (FIG. 1B) because the assembly 100 is detachably engageable with the case 112 but differs from medical device 1′ in that the assembly 100 can be engaged with any case of any internet-enabled device or directly with an internet-enabled device, provided a particularly configured cradle is provided on those other cases or internet-enabled devices.

Assembly 110 is engaged with case 112 which in turn is engaged around a portion of the exterior surface of cell phone 24. As best seen in FIG. 9, case 112 comprises a body having a top 112A spaced apart from a bottom 112B and defining therebetween a vertical direction. Case 112 further has a right side 112C spaced apart from a left side 112D and defining therebetween a horizontal or transverse direction. Case 112 further includes a rear 112E spaced apart from a front 112F (FIG. 2) and defining therebetween the thickness of case 112. Case 112 may be ergonomically shaped along its top, bottom, and sides 112A, 112B, 112C, 112D so as to fit comfortably within the hand of a user. Case 112 defines an aperture 112G therein which extends between rear 112E and front 112F. Aperture 112G is shaped and sized to be complementary to a region of cell phone 24 that includes camera 24G, microphone 24H, and LED 24J. The case 112 further included a plurality of projections 112H that are able to align with various buttons on cell phone 24.

In accordance with an aspect of the present disclosure, a cradle 126 is provided on the body of case 112. Cradle 126 is configured to house the assembly 110. Cradle 126, as illustrated, comprises a recess that is defined in case 112 and is accessible through an opening defined in rear 12E of case 112. (The terms “cradle 126” and “recess 126” may be used interchangeably herein) An interior surface of the case 112 which defines the recess 126 includes a top wall 126A, a bottom wall 126B, a right side wall 126C, a right side wall 126D that includes a notch 126E, and a front wall 126F. The interior surface defined by walls 126A through 126F bounds and defines the recess 126 and is complementary to a portion of an exterior surface of assembly 110 as will be discussed later herein. Apertures 126G are defined in right side wall 126C of case 112. The notch 126E and the apertures 126G are used in the engagement of assembly 110 within cradle 126 as will be described later herein. It will be understood that notch 126E and apertures 126G may be defined in any area of cradle 126 in order to enable assembly 110 to nest within cradle 126 and be secured therein. The specific locations of notch 126E and apertures 126G may differ from what is illustrated in FIG. 9.

The recess 126 defined in rear wall 112E of case 112 is generally square or rectangular in shape when case 112 is viewed from the back. It will be understood, however, that while cradle 126 is illustrated herein as being generally square when viewing the rear 12E of case 112, the recess 126 may be formed in any other desired location on case 112 and recess 126 may be of any desired configuration. For example, assembly 110 and cradle 126 may both be circular, triangular, or irregular in shape when viewed from the rear. Whatever shape of cradle 126 and assembly 110 is provided, the cradle 126 and assembly 110 are complementary to one another. Furthermore, the notch 126E may be provided in any location on any of the walls 126a through 126D. Assembly 110 that is to be received within cradle 126 will be complementary in size and shape to the recess 126 and is configured to be received within recess 126.

In accordance with a further aspect of the present disclosure, one or more charging and/or data pads 128A are provided on case 112. As illustrated, the charging and/or data pads 128A extend from a location on front wall 126F that bounds and defines recess 126 to interface/connect with charging node 128B on case 112 or with a charging and/or data port (not shown) on the cell phone 24. The charging and/or data ports 128B on the bottom 112B of case 112 may be operatively engaged with a remote power source or remote data source and/or may communicate with the charging and/or data port on the cell phone 24. The charging and/or data pads 128A and ports 128B form part of the cradle 126 provided on case 112. The location and type of pad 128A is merely exemplary and other embodiments could be used depending on the desired implementation. Alternatively, the at least one charging and/or data pad 128A may only connect to the remote power source rather than to the cell phone 24 or may only connect to the cell phone 24 rather than to the remote power source depending on the desired implementation.

Referring still to FIGS. 8 and 9, assembly 110 is illustrated. Assembly 110, as shown in FIG. 9, is shaped to be complementary to the recess 126 of case 112. Assembly 110 includes a top 110A, a bottom 110B, a right side 110C, a left side 110D, a rear 110E, and a front 110F. In assembly 110, top 110A is spaced apart from bottom 110B defining therebetween a vertical direction, the right side 110C is spaced apart from left side 110D defining therebetween a horizontal or transverse direction, and rear 110E is spaced apart from front 110F defining therebetween a thickness of the assembly 110. Top 11A, bottom 11B, right side 110C, left side 110D, and front 110F form an exterior surface of assembly 110 that is complementary in shape and size to the interior surface of cradle 126. Assembly 110 further includes at least one protrusion 110G on right side 110C and at least one engaging surface 110H on left side 110D of assembly 110. Protrusions 110G are located so as to be aligned with apertures 126G defined in cradle 126 of case 112 when assembly 110 is engaged with cradle 112. Engaging surface(s) 110H are located so as to be aligned with portions of the left side wall 126D of cradle 126 that are above and below the notch 126E. It will be understood that the location of the protrusions 110G and engaging surfaces 110H is complementary to the configuration of apertures 126G and surfaces of cradle 126. It will further be understood that protrusion(s) 110G and engaging surface(s) may be provided in any suitable location on the exterior surface of assembly 110 that will be received within complementary apertures 126C in cradle 126 or abut the interior surface of cradle 126, respectively, when assembly 110 is engaged with case 112. Furthermore, in one embodiment the engaging surface(s) 110H may each include a spring or other similar mechanism to enable the engaging surface 110H to flex and be held in static contact with the interior surface of cradle 126, thereby retaining the assembly 110 in tight contact with the cradle 126.

When assembly 110 is inserted into cradle 126 of case 112, protrusions 110G on assembly 110 are received in apertures 126G of cradle 126 and engaging surface 110H abut regions of left side wall 126D of cradle 126 so that assembly is tightly retained within cradle 126. In another embodiment, apertures may be provided on the assembly 110 and the projections for engagement in the apertures may be provided on the cradle 126. In yet another embodiment each of the assembly 110 and cradle 112 may include one or more projections and one or more complementary apertures. Similarly, engaging surfaces may be provided on cradle 126 for frictional engagement with regions of the exterior surface of the assembly 110 or each of the assembly 110 and cradle 126 may include some engaging surfaces and some regions that will be contacted by engaging surfaces of the other component. It will be understood that in yet other embodiments a different type of securement mechanism may be utilized to retain assembly 110 in cradle 126.

When assembly 110 is inserted into and secured within cradle 126 of case 112, rear 110E of assembly 110 is substantially flush with rear 112E of case 112. If at a later time, the user wishes to remove assembly 110 from cradle 112, a flat-tipped instrument, such as a flat-head screwdriver, may be inserted into notch 126E. The tip of the flat-tipped instrument will be brought into engagement with left side 110D of assembly 110 and pressure will be applied to the left side 110D in order to dislodge assembly 110 from its nesting position within cradle 126.

Referring still to FIGS. 8 and 9, the body of assembly 110, similar to the body of assembly 10, includes an emergency button 14, a multifunction button 16, a microphone 18, a speaker 20, and an indicator light 22. Emergency button 14, multifunction button 16, microphone 18, speaker 20, and/or indicator light 22 are integrated into assembly 110. These operational components can be interfaced in such a way that each of these components interacts with a processor within assembly 110. Furthermore, when assembly 110 is engaged within cradle 126 of case 112, and case 112 is engaged with cell phone 24, the operational components of device 100 interface with the components of cell phone 24. According to another aspect, any or all of the emergency button 14, multifunction buttons 16, microphone 18, speaker 20, and indicator light 22 may be provided at any desired location on assembly 110.

The main operational components, namely, emergency button 14, multifunction button 16, microphone 18, speaker 20, and/or indicator light 22 may be integrated into device 100 or the case 12 and are physically or wirelessly connected. It will be understood that all of the components illustrated in FIG. 2 and discussed previously herein as being provided on assembly 10 or 10′ are provided in assembly 110 and are used in the same manner as discussed previously herein. Additionally, it will be understood that all components of assembly 110 interact with cell phone 24 in an identical manner as discussed with respect to assembly 10 and 10′. Assembly 110 may control the various components of cell phone 24 as if the cell phone is an extension of assembly 110 or, alternatively, the cell phone 24 may control the various components of device 100 as if device 100 is an extension of the cell phone 24 itself.

It will further be understood that assembly 110 may be charged in an identical manner to assembly 10, 10′ as discussed previously herein with respect to FIGS. 3 to 5B.

It should be noted that assembly 110 is a third exemplary embodiment of a device in accordance with the present disclosure. Other alternative embodiments of the device are contemplated in which features may be duplicated or eliminated as desired and as dictated by the desired implementation and may lead to a combination of the features of the first embodiment, second embodiment and/or third embodiment disclosed herein.

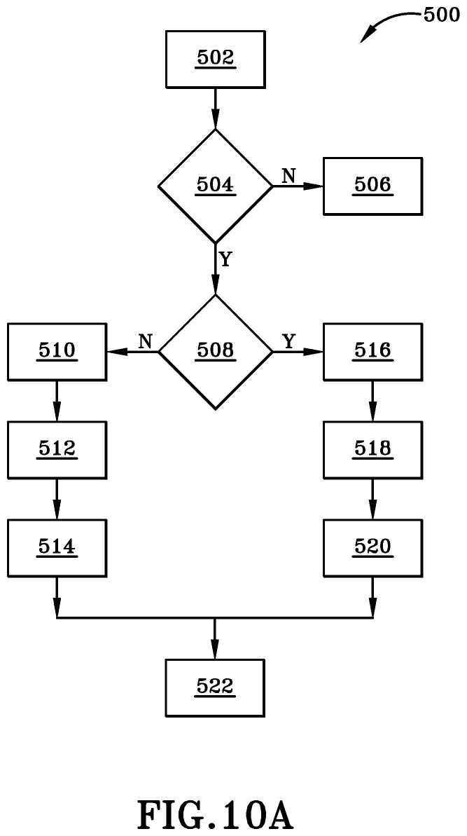

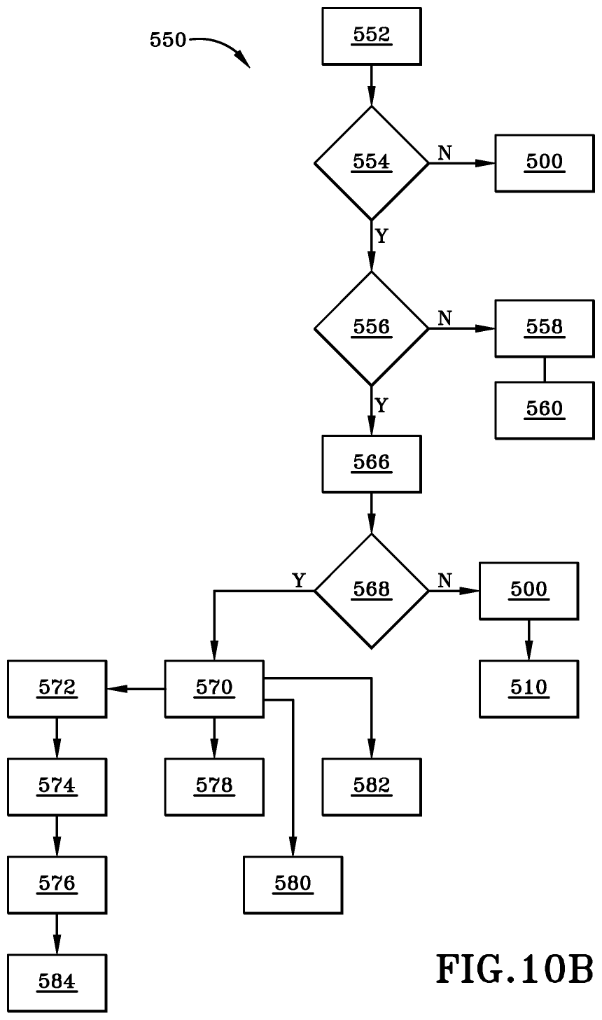

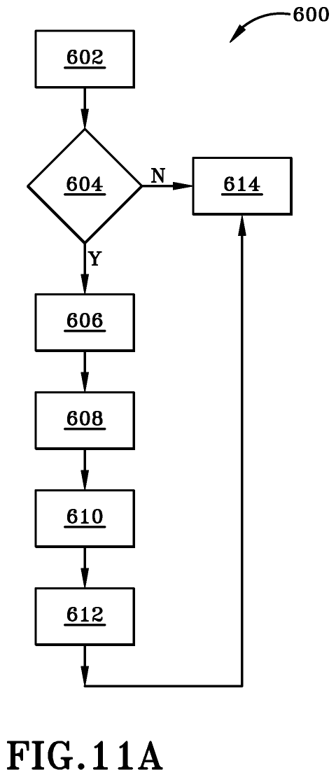

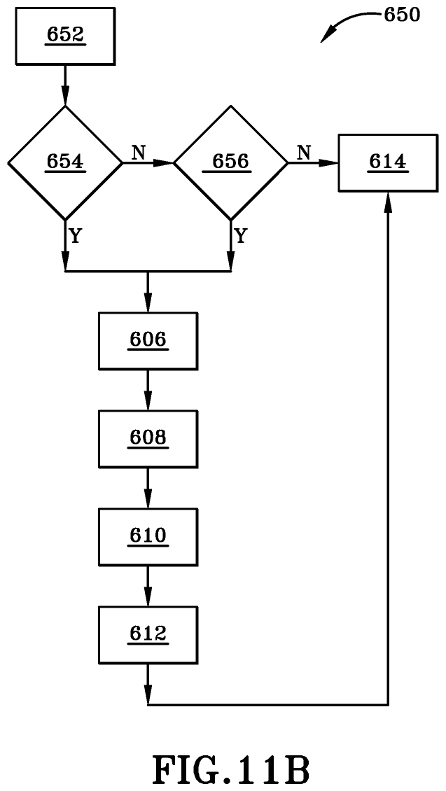

FIGS. 10A through 11A show flowcharts and decision trees that are applicable to any and all of medical device 1, 1′ and 100 described above. These flowcharts and decision trees will be discussed referred to medical device 100 and therefore reference assembly 110, case 112 and cell phone 24 but it will be understood that the described applies equally to medical devices 1 and 1′.

FIG. 10 shows a flowchart and decision tree for a process 500. Process 500 is an exemplary process that may be automatically followed or employed by medical device 100 when a user depresses the emergency button 14 thereon. Prior to the emergency button 14 being depressed, the device 100 is in a dormant, standby mode awaiting activation. Process 500 begins with step 502 where the emergency button 14 of assembly 110 is depressed or pushed by a user of the cell phone or by someone who comes upon an incapacitated user and utilizes the device 100 to call for emergency assistance. Depressing emergency button 14 wakes the device 100 out of standby mode and, as described earlier herein, in some instances a GUI on screen 24K displays options for the user to select.

Upon device 100 registering that the emergency button 14 has been pushed, step 504 is a decision step wherein the user-of is given the opportunity to decide if they wish to proceed with the emergency call or if they wish to cancel the emergency call. For example, if pressing the emergency button 14 was intentional; i.e., there is, in fact, an emergency and the user requires assistance, (which is indicated by the symbol “Y” off box 504 in the flowchart), the user may do nothing and the device 100 will then proceed automatically with the next several steps of process 500.

If depressing the emergency button 14 was accidental and the user does not require emergency assistance, (indicated by the symbol “N” off the box 504 in the flowchart), the user will decide to cancel the call. Canceling the emergency call can be accomplished by using the multifunction button 16 as discussed previously herein or by selecting option 1 on the GUI on cell phone 24 as discussed previously herein, or by any other programmed action, such as by depressing the emergency button 14 a second time, or the like. A time delay may be programmed into device 100 to allow the user a short period of time to make the decision as to whether or not to cancel the emergency call after depressing emergency button 14. The period of time may, for example, be thirty to forty-five seconds. The cancellation of an emergency call is indicated as step 506 in process 500. If the call is canceled, the process 500 will end and the device 100 will reset and return to a normal standby mode. The standby mode will cease when the emergency button 14 is depressed again at a later time, reinitiating the process at step 502.

Assuming that an emergency does exist for the user of device 100 or for another person in the user's immediate surroundings, assembly 110 and the cancel call option of process 500 will not be selected, and the device 100 will move to the next step in the process 500, indicated as step 508. In step 508 the device 100 will determine if there is an internet/data connection available to medical device 100 via a Wi-Fi connection or the like. Either device 100 will find an internet/data connection which is indicated by the symbol “Y” off box 508 in the flowchart, or device 100 will not find an internet/data connection and will therefore follow a different path which will be described later herein. The failure of device 100 to find an internet/data connection is indicated by the symbol “N” off box 508 of the flowchart.

If there is an internet/data connection available to device 100, then assembly 110 sends out one or more emergency signals as described previously herein. Consequently, device 100 will send out an emergency signal 62 (FIG. 6) to emergency services 64 (indicated at box 516 in the flow chart). Device 100 may also send out one or more video signals 66 (FIG. 6) to one or more emergency contacts 68 (only one of which is shown in FIG. 6), and may further optionally send out a group message signal 70 to contact group 72. The sending out of these various emergency signals 62, 66, and 70 is indicated as step 516 in the process 500 shown in FIG. 10A. In step 518, device 100 may also activate GPS on assembly 110 or cell phone 24 to provide the location of device 100 to emergency services personnel. In step 520, device 100 activates the microphone 18 and speaker 20 on assembly 110 (or a microphone and speaker on cell phone 24) so that two-way communication may be established between the user of device 100, emergency services 64 (FIG. 6), the other emergency contacts 68, and any of the contact group 72 stored in the memory 34 of assembly 110.

Referring still to the flowchart in FIG. 10A, if in step 508 no internet/data connection is found to be available, assembly 110 may proceed to a step 510 in the process 500. Step 510 involves the device 100 sending out an emergency signal 62 (FIG. 6) in an attempt to contact emergency services 64 without having an internet/data connection and will activate GPS in step 512, and microphone 18 and speaker 20 in step 514 in hopes of establishing two-way communication with a dispatcher at emergency services 64 (FIG. 6). The activation of GPS will at least give emergency personnel notification of the location of the device 100 and therefore OF the user even if two-way communication cannot be established. If the initial attempt at sending out the emergency signal 62 without internet/data connection is unsuccessful, device 100 may send out another emergency signal 62 after an interval of time in a further attempt to make contact with emergency services 64. Device 100 may continue to try and contact emergency services 64 for a preset number of attempts or until steps are taken to cancel the initiated emergency as described with respect to step 506.

Step 522 of the process 500 signifies that emergency services 64 has dispatched personnel to the location of the user experiencing the medical emergency and therefore the process 500 is terminated. When the user is reached by the emergency services personnel, assistance is provided to the user. At some point after emergency services arrives at the user's location, two-way communication between device 100 and the emergency services' dispatcher is disconnected. This is indicated at step 522. Disconnection may be accomplished manually, i.e. through an act of the user depressing emergency button 14 on their device again or interacting with the GUI on screen 24K (FIG. 7) or otherwise cutting off communication in another manner such as by depressing one of the multifunction buttons 16. Alternatively, emergency services personnel may manually terminate the connection between emergency services 64 and device 100. Further, the disconnection may occur automatically via the dispatch system of emergency services 64. Disconnection of device 100 from emergency services' dispatch occurs regardless of whether assembly 110 is connected to an internet/data connection or not. Once disconnected, device 100 returns to standby mode until emergency button 14 is depressed yet again in step 502 of process 500. Alternatively, returning to step 510 of the process 500, if no attempt at contacting emergency services 64 has been successful, the process 500 terminates at step 522 by the user terminating the process as described above or by the number of attempts at reaching emergency services 64 passing a preprogrammed limit.

It will be understood that the various steps in process 500 may be performed in any suitable order and some steps may be performed simultaneously or substantially simultaneously. For example, the activation of the microphone 18 and speaker 20 may occur simultaneously or effectively contemporaneously with sending out the emergency signal 62.

With reference to FIG. 10B, a flowchart and decision tree is shown and indicated as process 550. Process 550 is an exemplary process that may be automatically followed or employed by assembly 110 operatively coupled with the cell phone 24 when a user depresses the emergency button 14. Accordingly, process 550 begins with step 552 wherein the emergency button 14 on device 100 is depressed by the user or by a person having access to the phone in the vicinity of the user. Upon device 100 registering that the emergency button 14 has been pushed, the assembly 110 confirms whether it is connected to the cell phone 24 or not, as indicated at step 554. If assembly 110 succeeds in connecting to cell phone 24 or confirms it is connected to cell phone 24 via BLUETOOTH®, NFC, or a physical connection, as indicated by the symbol “Y”, the process 550 continues to step 556. If assembly 110 determines there is no connection between itself and cell phone 24 or if a connection cannot be established, as indicated by the symbol “N”, then process 500 (FIG. 10A) as described earlier herein is undertaken.

Step 556 in process 550 is a decision step wherein the user of device 100 is given the opportunity to cancel the emergency signal initiated by the depressing of emergency button 14. If depressing the emergency button 14 was intentional; i.e., there is, in fact, an emergency, the user does not need to do anything and device 100 will automatically proceed with the next steps of process 550. Alternatively, the user may utilize the GUI on the screen 24K (FIG. 7) to confirm there is a medical emergency and they need assistance. In particular, the user may engage the SOS option 86 on the GUI to confirm their need of assistance. The step of the user actively confirming there is a medical emergency is indicated as step 566 in process 550.

If pressing the emergency button 14 was accidental and there is no medical emergency for which assistance is required, as indicated by the symbol “N” extending from step 556, the user may cancel the emergency call. The emergency call is cancelled by using the multifunction button 16 or through use of the GUI on the cell phone 24 or by any other programmed action, such as pressing the emergency button 14 a second time, as discussed previously herein with respect to step 506 (FIG. 10A) in process 500. The cancellation of the emergency call is indicated as step 558 in process 550 and the process 550 will terminate until reinitiated when a person once against depresses emergency button 14 on device 100. Step 560 as indicated in the flowchart indicates that the user has selected to use the GUI on the cell phone screen to cancel the emergency call.

After receiving confirmation that an emergency exists in step 566 of process 550 (or by the user not canceling the emergency call), device 100 will then determine if there is an internet/data connection available to assembly 110 via the cell phone 24. The check for an internet and/or data connection is indicated as step 568 in process 550. If there is no connection, indicated by the symbol “N” extending from box 568, the assembly 110 will revert to process 500, namely to step 510 (FIG. 10A) of process 500.

If device 100 determines there is an internet/data connection via the cell phone 24 available, the device 100 utilizes that internet/data connection to connect to emergency services in step 570. In particular, in step 570 device 100 will send out emergency signals 62, and or 66 and 70 as described earlier herein. The assembly 110 then activates various components that may be located on assembly 110 and/or cell phone 24. By way of example, the programming of assembly 110 may activate the assembly's microphone 18 in step 572 and activate the assembly's speaker 20 in step 574 to allow for two-way communications between the user of assembly 110 and a dispatcher at emergency services 64 (FIG. 6). Alternatively, in steps 572 and 574 the assembly 110 may activate the cell phone's microphone 24H (FIGS. 1 and 4) and speaker (not shown). Additionally, the cell phone's camera 24G and any other required components and functions of cell phone 24 may be activated by assembly 110 in step 576 in order to enable two-way communication to be established between the user and the dispatcher at emergency services.

Where assembly 110 is connected to or otherwise able to utilize an internet or data connection as determined in step 568, device 100 may connect to the preprogrammed video contact 68 (FIG. 6) by way of sending a video signal 66 to the video contact. The connection to the video contact 68 is indicated as step 578 in process 550. The cell phone's camera may be activated (in step 576) prior to, simultaneously with, or after the signal 66 is sent to the video contact 68. Contacting the video contact 68 may occur substantially simultaneously with sending out the signal 62 to emergency services 64.

In addition to connecting to the video contact 68, assembly 110 (or cell phone 24) may also generate a group messaging signal 70 (FIG. 6) and send that signal out to the preprogrammed contact group 72, as indicated in step 580 of process 550. As discussed above, while the video signal 66 and group messaging signal 70 are being sent, assembly 110 (or cell phone 24) may simultaneously also activate the microphone(s), speaker(s) in steps 572 and 574, respectively. Additionally, camera 24G and screen 24K of cell phone 24 may be activated substantially simultaneously with the microphone(s) and speaker(s). Furthermore, the assembly 110 may also activate GPS in step 582. As a result of activating the GPS, the assembly 110 may also send a group messaging signal 70 to trusted contacts with the GPS coordinates of the assembly 110 and may provide the same information to emergency services 64.

Once emergency services 64 has responded to the user's emergency and upon completion of the emergency call, which may vary depending on the specific circumstances surrounding the emergency, the emergency services connection may be completed and ended in step 584, thus completing process 550. Step 584 may be accomplished manually, i.e. through an active act of the user to cancel or otherwise terminate the connection, or automatically via a disconnection from emergency services 64. As further discussed above with regards to the emergency services 64 contact, once the desired contacts and/or transmissions are over, the connections to emergency services 64, video contact 60, and/or the contact group 72 may be ended or terminated as step 584 of process 550. It will be understood that a number of the steps of process 550 may be performed in any suitable order and some steps may be performed simultaneously.

With reference to FIG. 11A, a further process is shown and indicated as process 600. This process may involve similar steps to those of process 500 but is contemplated to be a process utilized by device 100 and the user thereof when a video connection to video contact 68 is desired but not in the instance of an emergency. According to one aspect, as provided in an example above, a video connection to the video contact 68 may be desired in situations where there is a minor illness or injury, or in another scenario that warrants video contact while a connection to emergency services 64 is undesirable or not required. It is in these types of scenarios that process 600 may be employed. Accordingly, process 600 may begin with the depression of multifunction button 16 (FIGS. 1 and 4) in step 602. As with process 500, the next step in process 600 following the depression of multifunction button 16 is for device 100 to check and determine if an internet and/or data connection is available. This step is indicated as step 604 in process 600.

Assuming a connection to the internet or to a data source is available to assembly 110, indicated by the symbol “Y” coming off step 604, the next step, indicated as step 606, is to generate the video signal 66 to connect to video contact 60. Simultaneously, or in succession thereto, assembly 110 may activate the camera 24G of the cell phone in step 608, activate the microphone in step 610, and activate the speaker in step 612 to allow a two-way audio connection between the user of assembly 110 and the video contact 60. Once the video connection is complete and the user of assembly 110 and video contact 68 have concluded their video chat, the connection therebetween may be disconnected in step 614.

As seen in FIG. 11A at step 604, if medical device 100 determines there is no available internet or data connection at the time of pressing the multifunction button 18, indicated by the symbol “N” coming off step 604, assembly 110 will forego the connection and activation of other components of device 100 and cell phone 24, and disconnect or end the connection attempt via step 614 as indicated.

With reference to FIG. 11B, a further process is shown and indicated as process 650. This process may involve similar steps to those of process 600 but is contemplated to be a process utilized by device 100 and the user thereof when a video connection to video contact 68 is desired but not in the instance of an emergency with use with cell phone 24. According to one aspect, as provided in an example above, a video connection to the video contact 68 may be desired in situations where there is a minor illness or injury, or in another scenario that warrants video contact while a connection to emergency services 64 is undesirable or not required. It is in these types of scenarios that process 650 may be employed. Accordingly, process 650 may begin with the depression of multifunction button 16 in step 652. As with process 600, the next step in process 650 following the depression of multifunction button 16 is for assembly 110 to check and determine if an internet and/or data connection is available. This step is indicated as step 654 in process 650.

In process 600, if medical device 100 determines there is no available internet or data connection at the time of pressing the multifunction button 18, assembly 110 may forego the connection and activation of other components, and may disconnect or end the connection attempt via step 614 as indicated. However, in contrast to process 600, if no internet connection is determined, as indicated by the symbol “N” coming out of box 654 in the flowchart illustrated in FIG. 11B, the assembly 110 may interface with the cell phone 24 via BLUETOOTH®, NFC or other such operative connection to allow the cell phone 24 to share its internet connection via step 656. If medical device 100 determines there is no available internet or data connection available via the cell phone 24 at the time of pressing the multifunction button 18, as indicated by the symbol “N” coming from box 656, the device 100 may forego the connection attempt and activation of other components, and may disconnect via step 656 or end the connection attempt via step 614 as indicated.

If however, as indicated by the symbols “Y” coming from steps 654 and 656, a connection to the internet or to a data source is available to device 100, the next step, indicated as step 606, is to generate the video signal 66 to connect to video contact 68. Simultaneously, or in succession thereto, assembly 110 may activate the camera 24G of the cell phone 24 in step 608, activate the microphone 18 of assembly 110 in step 610, and activate the speaker 20 of assembly 110 in step 612 to allow a two-way audio connection between the user of assembly 110 and the video contact 60. (Alternatively, the cell phone's microphone and speaker may be activated by assembly 110.) Once the video call is complete and the user of assembly 110 and video contact 68 have concluded their video chat, the connect therebetween may be disconnected in step 614.

According to another aspect of the present disclosure indicator light 22 on assembly 110 may be used to show that assembly 110 is powered on and is active. According to yet another aspect, indicator light 22 may be used to indicate an active and open connection to one or more of emergency services 64, video contact 68, and/or contact group 72. For example, a blinking light or a specific light color displayed by the indicator light 22 may be utilized to indicate a connection to emergency services 64 while a different blinking pattern (e.g. a faster or slower blink, as desired) or color may indicate an active video connection to video contact 60, and a further different pattern or color may indicate an active connection to contact group 72. When assembly 110 returns to its standby mode (when the emergency call is terminated), the indicator light 22 is extinguished to indicate that the assembly 110 is no longer powered or active.

While in the exemplary embodiments of device 100 the emergency medical emergency button 14 is described herein as being applied to a cell phone 24, it will be understood in other embodiments the emergency medical emergency button 14 may be provided on any of a variety of other electronic communications devices that have internet connectivity, including but not limited to a tablet, a smart watch, a Personal Digital Assistant (PDA), a laptop computer, a smart TV, an eBook reader, a gaming console, home appliances such as remote controls, and a desktop computer. Some of these other electronic communications devices may include cases or covers with which the assembly 10, 10′, or 110 may be engaged. In other instances, the assembly 10 may be an integral part of the internet-enabled other electronic communications device or the housing of the other communications device may be formed to include a cradle suitable for engagement of assembly 10′ or 110. The engagement of assembly 10, 10′, 110 with any of these internet-enabled devices will turn these devices into personal medical devices that may be utilized to send emergency medical calls as described herein.

Although the case 12, 12′, 112 is shown and discussed herein as having the general appearance of an outer shell of the cell phone 24 as a cell phone case, it will be understood that medical device 1, 1′, 100 could be any suitably sized and/or shaped device as chosen and dictated by the desired implementation. For example, medical device 1, 1′, 100 could be readily configured in a multitude of sizes to fit and/or properly interface with the case 12, 12′, 112 which houses the cell phone 24. Therefore, it will be understood that although the components 12, 12′ and 112 are shown and described herein as a “cell phone” case, medical device 1, 1′, 100 may be any suitable personal medical device capable of carrying out the operations described herein and the case that forms a part thereof will be chosen in accordance with the configuration of the internet-enabled device.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “element A and/or element B”, when used in conjunction with open-ended language such as “comprising” can refer, in one embodiment, to element A only (optionally including elements other than element B); in another embodiment, to element B only (optionally including elements other than element A); in yet another embodiment, to both element A and element B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A medical device comprising:
a first piece of electronics;
a case that extends around at least a portion of the first piece of electronics; and
a second piece of electronics provided on the case, wherein the second piece of electronics is operative to notify emergency services of a medical emergency of a user of the first piece of electronics.

2. The medical device of claim 1, wherein the first piece of electronics is an internet-enabled device and the case extends around at least a portion of the internet-enabled device; and wherein the second piece of electronics is an assembly provided on the case and having an emergency button operative to be depressed by the user; and wherein through depression of the emergency button, the medical device is operative to notify emergency services of the medical emergency of the user.

3. The medical device of claim 2, wherein the internet-enabled device is one of a cell phone, a tablet, a smart watch, a Personal Digital Assistant (PDA), a laptop computer, an eBook reader, a gaming console, and a remote control.

4. The medical device of claim 3, wherein the internet-enabled device is a cell phone and the case is a cell phone case.

5. The medical device of claim 2, wherein the internet-enabled device is paired to the assembly.

6. The medical device of claim 2, wherein the internet-enabled device includes a screen.

7. The medical device of claim 6, wherein the screen is operative to display a graphical user interface (GUI) in response to the depression of the emergency button.

8. The medical device of claim 2, further comprising one or both of a microphone and a speaker which is activated in response to the depression of the emergency button,

9. The medical device of claim 2, further comprising a screen and a camera provided on the internet-enabled device, wherein the screen and camera are selectively activated when the emergency button is depressed.

10. The medical device of claim 2, further comprising an indicator light provided on one of the case and the assembly, wherein said indicator light is operative to illuminate when the medical device is in an active state.

11. The medical device of claim 2, further comprising a battery provided in the assembly.

12. The medical device of claim 2, wherein the case includes a cradle and the assembly is selectively detachably engaged with the cradle.

13. The medical device of claim 2, wherein the internet-enabled device includes one or more of a processor, a keypad control module, one or more memory modules, a vibration motor, a cellular transceiver, a wireless transceiver, a Near Field Communication (NFC) transceiver, an FM transceiver, a receiver, a multifunction input/output device, and a cellular network subscriber identification module (SIM).

14. The medical device of claim 2, further comprising a connection between the internet-enabled device and the assembly.

15. The medical device of claim 14, wherein the connection is a physical connection.

16. The medical device of claim 14, wherein the connection is a wireless connection.

17. A method for contacting emergency services comprising:
providing a first piece of electronics;
engaging a case with at least a portion of the first piece of electronics;
providing a second piece of electronics on the case;
activating the second piece of electronics; and
sending an emergency signal to emergency services.

18. The method of claim 17, wherein providing the first piece of electronics comprises providing an internet-enabled device; and providing the second piece of electronics includes providing an emergency button the case for the internet-enabled device; and wherein the method further comprises:
depressing the emergency button provided on the case;
searching for an internet or data connection;
sending the emergency signal to emergency services using the internet or data connection located in the search; and
connecting the internet-enabled device to the emergency services.

19. The method of claim 18, further comprising:
providing a cell phone as the first piece of electronic equipment; and
pairing the cell phone and the emergency button.

20. The method of claim 19, further comprising:
displaying a graphical user interface (GUI) on a screen of the cell phone in response to the depression of the emergency button.
